(19) United States
(12) Patent Application Publication
(10) Pub. No.: US 2015/0151329 A1
(43) Pub. Date: Jun. 4, 2015

(54) Pattern Forming Method

(71) Applicant: Kabushiki Kaisha Toshiba, Tokyo (JP)

(72) Inventors: Ayako KAWANISHI, Yokohama-Shi (JP); Hirokazu Kato, Kariya-Shi (JP); Hiroki Yonemitsu, Kawasaki-shi (JP); Yusuke Kasahara, Yokohama-shi (JP)

(73) Assignee: Kabushiki Kaisha Toshiba, Tokyo (JP)

(21) Appl. No.: 14/191,869

(22) Filed: Feb. 27, 2014

Related U.S. Application Data
(60) Provisional application No. 61/910,588, filed on Dec. 2, 2013.

(51) Int. Cl. B05D 7/00; B05D 3/06

(52) U.S. Cl. CPC B05D 7/52; B05D 3/065

(57) ABSTRACT

In a pattern forming method according to the present embodiment, a first guide layer having a first pattern is formed above a base material. A second guide layer having a second pattern intersecting the first pattern is formed. A directed self-assembly material is introduced in a concave portion surrounded by the first and second guide layers. A directed self-assembly pattern having a diameter which is smaller than an opening diameter of the concave portion is formed in the concave portion by causing the directed self-assembly material to be directed self-assembled.

### CROSS REFERENCE TO RELATED APPLICATIONS

This application is based upon and claims the benefit of priority from the prior U.S. Provisional Patent Application No. 61/910,588, filed on Dec. 2, 2013, the entire contents of which are incorporated herein by reference.

### FIELD

Embodiments relate to a pattern forming method.

### BACKGROUND

In recent years, a lithography technique using a Directed Self-Assembly (hereinafter, also “DSA”) material has been developed. The shape of the DSA material can be phase-separated into various ones such as sphere, cylinder, or lamella depending on the composition ratio of blocks of a high-molecular block copolymer. Furthermore, by adjusting molecular weight, the DSA material can form a dot pattern, a hole pattern, a pillar pattern, a line pattern and the like with various dimensions. When patterns of such various forms and various dimensions are formed, it is necessary to provide a guide that controls a forming position of a polymer phase formed by DSA.

Types of the guide includes a physical guide (grapho-epitaxy) that can form a microphase separation pattern in a concave portion of a concave-convex structure and a chemical guide (chemical-epitaxy) that controls a forming position of a microphase separation pattern based on a difference of surface energies of base materials.

When the physical guide is used, it is formed by a photolithography technique. Therefore, the minimum size of the physical guide is determined by limitations on the photolithography technique. This determination leads to limitations on downscaling of a DSA pattern formed by the physical guide. For example, when hole patterns generated by the photolithography technique are the physical guide, there are limitations on narrowing a gap between two adjacent hole patterns. In this case, even when DSA is used, the gap between hole patterns becomes hindrance of downscaling.

When a physical guide including a line and space pattern (hereinafter, also “LS pattern”) is used, it has been difficult to orient DSA materials aligned in a lined shape in the same direction. That is, control of the orientation of DSA materials has been difficult.

### BRIEF DESCRIPTION OF THE DRAWINGS

FIGS. 1A, 2A, 3A, 4A, 5A, and 6A are plan views of an example of a pattern forming method according to a first embodiment;

FIGS. 1B, 2B, 3B, 4B, 5B, and 6B are sectional views of an example of the pattern forming method according to the first embodiment;

FIGS. 7A and 7B are a plan view and a sectional view of a neutral film 70 formed on the hard mask 30 before forming the resist films 40 and 50;

FIGS. 8A, 9A, 10A, 11A, and 12A are plan views of an example of a pattern forming method according to a second embodiment;

FIGS. 8B, 9B, 10B, 11B, and 12B and FIGS. 8C, 9C, 10C, 11C, and 12C are sectional views of an example of the pattern forming method according to the second embodiment;

FIG. 13A is a plan view showing phase-separation of a copolymer using an LS pattern;

FIG. 13B is a plan view showing phase-separation of a copolymer using a cross-point pattern;

FIGS. 14A, 15A, 16A, 17A, 18A, 19A, 20A, 21A, and 22A are plan views of an example of a pattern forming method according to a third embodiment;

FIGS. 14B, 15B, 16B, 17B, 18B, 19B, 20B, 21B, and 22B and FIGS. 14C, 15C, 16C, 17C, 18C, 19C, 20C, 21C, and 22C are sectional views of an example of the pattern forming method according to the third embodiment;

FIGS. 23A, 24A, 25A, 26A, and 27A are plan views of an example of a pattern forming method according to a fourth embodiment; and

FIGS. 23B, 24B, 25B, 26B, and 27B are sectional views of an example of the pattern forming method according to the fourth embodiment.

### DETAILED DESCRIPTION

Embodiments will now be explained with reference to the accompanying drawings. The present invention is not limited to the embodiments.

In a pattern forming method according to the present embodiment, a first guide layer having a first pattern is formed above a base material. A second guide layer having a second pattern intersecting the first pattern is formed. A directed self-assembly material is introduced in a concave portion surrounded by the first and second guide layers. A directed self-assembly pattern having a diameter which is smaller than an opening diameter of the concave portion is formed in the concave portion by causing the directed self-assembly material to be phase-separated.

### First Embodiment

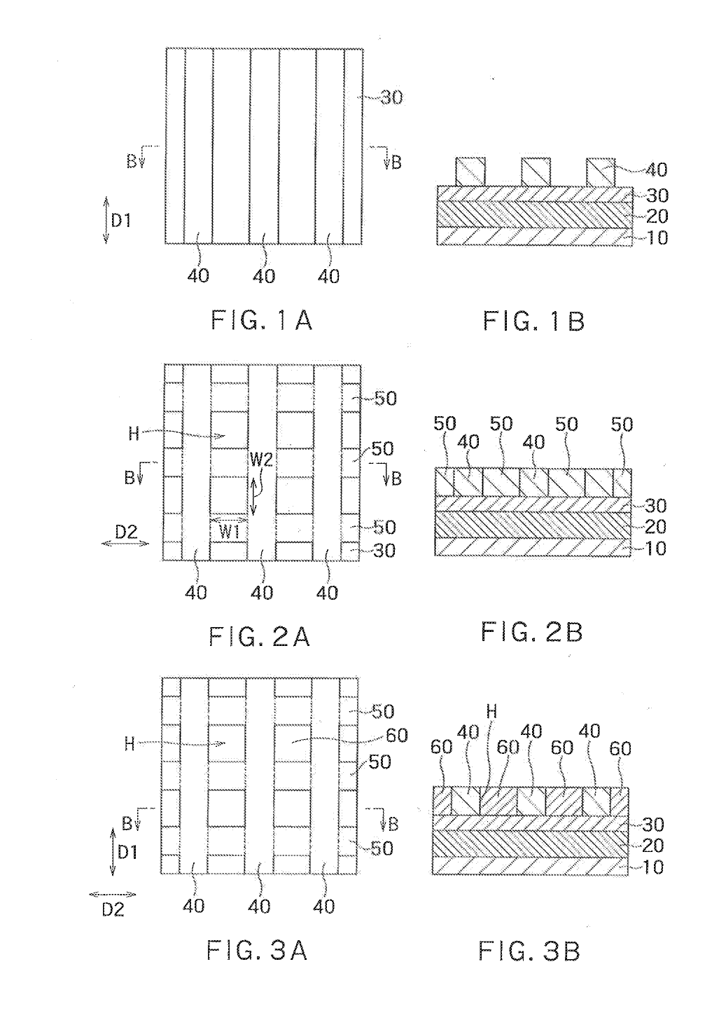

FIGS. 1A, 2A, 3A, 4A, 5A, and 6A are plan views of an example of a pattern forming method according to a first embodiment. FIGS. 1B, 2B, 3B, 4B, 5B, and 6B are sectional views of an example of the pattern forming method according to the first embodiment. FIGS. 1B to 6B are sectional views along with a line B-B of respectively corresponding FIGS. 1A to 6A.

First, as shown in FIG. 1B, materials of a processing target film 20 and of a hard mask 30 are deposited on a substrate 10. In the first embodiment, the processing target film 20 and the hard mask 30 are a base material. When the substrate 10 is processed, the substrate 10 can be also included in the base material. The substrate 10 can include, but is not limited to, a silicon substrate. The material of the processing target film 20 can include, but is also not limited to, a material such as polysilicon, silicon single crystal, or SOC (Spin On Carbon). The thickness of the processing target film 20 is, for example, approximately 100 nm. The material of the hard mask 30 is preferably different from that of the processing target film 20 (preferably a material having an etching rate lower than that of the processing target film 20), and the material of the hard mask 30 can be an insulation film such as a silicon dioxide film (such as SOG (Spin On Glass)) or a silicon nitride film. The thickness of the hard mask 30 is, for example, approximately 20 nm.

Next, a negative resist film 40 (hereinafter, “resist film 40”) is coated on the hard mask 30 and the resist film 40 is exposed by ArF excimer laser. By developing the resist film 40, as shown in FIG. 1A, a stripe-shaped LS pattern (first pattern) extending in a first direction D1 is formed. The film thickness of the resist film 40 is, for example, approximately 100 nm. The line width and the space width of the LS pattern of the resist film 40 are respectively, for example, approximately 35 nm. That is, a half pitch of the LS pattern of the resist film 40 is, for example, approximately 35 nm.

Next, a negative resist film 50 (hereinafter, “resist film 50”) is coated on the resist film 40 and the hard mask 30 and the resist film 50 is exposed by ArF excimer laser. By developing the resist film 50, as shown in FIG. 2A, a stripe-shaped LS pattern (second pattern) is formed such that the LS pattern intersects with the pattern of the resist film 40. In the first embodiment, the pattern of the resist film 50 extends in a second direction D2 that is substantially orthogonal to the first direction D1 and intersects with the pattern of the resist film 40. The film thickness of the resist film 50 is, for example, approximately 100 nm. The line width and the space width of the LS pattern of the resist film 50 are respectively, for example, approximately 35 nm. That is, similarly to that of the resist film 40, the half pitch of the LS pattern of the resist film 50 is, for example, also approximately 35 nm.

In this manner, the resist film 40 and the resist film 50 as the first guide and the second guide, respectively, intersect with each other to form a cross-point pattern. A part surrounded by the resist film 40 and the resist film 50 becomes a concave portion (a hole portion) having the hard mask 30 as a bottom surface. That is, it can be rephrased that the resist films 40 and 50 form a hole pattern H. In this case, a half pitch of the hole pattern H (opening widths W1 and W2 of the concave portion) becomes, for example, approximately 35 nm. As described later, the resist films 40 and 50 function as a physical guide in DSA lithography processing. The resist film 40 functions as a first guide layer and the resist film 50 functions as a second guide layer.

Next, as shown in FIGS. 3A and 3B, a DSA material (hereinafter, also “block copolymer layer”) 60 is introduced in the concave portion of the hole pattern H. More specifically, for example, as the material of the block copolymer layer 60, a block copolymer (hereinafter, also “PS-b-PMMA”; available from Polymer Source Inc.) of polystyrene (hereinafter, also “PS”) and polymethylmethacrylate (hereinafter, also “PMMA”) is used. Sidewalls of the concave portion of the hole pattern H (sidewalls of a physical guide) are the resist films 40 and 50 and these sidewalls are made of a same material. Therefore, when PS-b-PMMA in the physical guide is phase-separated into PS and PMMA, the PMMA is formed in a cylindrical structure with a diameter of approximately 20 nm and the PS surrounds the PMMA. Therefore, in the first embodiment, a PS-b-PMMA solution with a concentration of approximately 2.0 Wt % is made by using polypropylene glycol monomethyl ether acetate (hereinafter, also “PGMEA”) as a solvent. This PS-b-PMMA solution is coated on the resist films 40 and 50 and the hard mask 30. At this time, the PS-b-PMMA solution is spin-coated with a revolution number of, for example, approximately 1500 rpm. With this process, as shown in FIGS. 3A and 3B, the PS-b-PMMA solution is introduced in the concave portion of the hole pattern H.

The material of the block copolymer layer 60 is not limited to PS-b-PMMA, and can be made of other materials, including polybutadiene-polydimethylsiloxane, polybutadiene-4-vinylpyridine, polybutadiene-methyl methacrylate, polybutadiene-poly-t-butyl methacrylate, polybutadiene-t-butyl acrylate, poly-t-butyl methacrylate-poly-4-vinylpyridine, polyethylene-polymethyl methacrylate, poly-t-butyl methacrylate-poly-2-vinylpyridine, polyethylene-poly-2-vinylpyridine, polyethylene-poly-4-vinylpyridine, polyisoprene-poly-2-vinylpyridine, poly-t-butyl methacrylate-polystyrene, polymethyl acrylate-polystyrene, polybutadiene-polystyrene, polystyrene-poly-2-vinylpyridine, polystyrene-poly-N, N-dimethylacrylamide, polybutadiene-sodium polyacrylate, polybutadiene-polyethylene oxide, poly-t-butyl methacrylate-polyethylene oxide, polystyrene-polyacrylate, polystyrene-polymethacrylic acid, polystyrene-polymethyl methacrylate (PS-PMMA), polystyrene-polyethylene oxide (PS-PEO), polystyrene-polydimethylsiloxane (PS-PDMS), polystyrene-polyisoprene (PS-PI), polystyrene-poly-4-vlnylpyridine (PS-P4VD), and polymethyl methacrylate-polymethacrylate containing polyhedral oligomeric silsesquloxane (PMMA-PMAPOSS) and the like. When a phase separation pitch becomes different according to the material used for the block copolymer layer 60, the width (size) of the hole pattern H needs to be set according to the phase separation pitch. Conditions of the width of the hole pattern H (conditions of the physical guide) are described later.

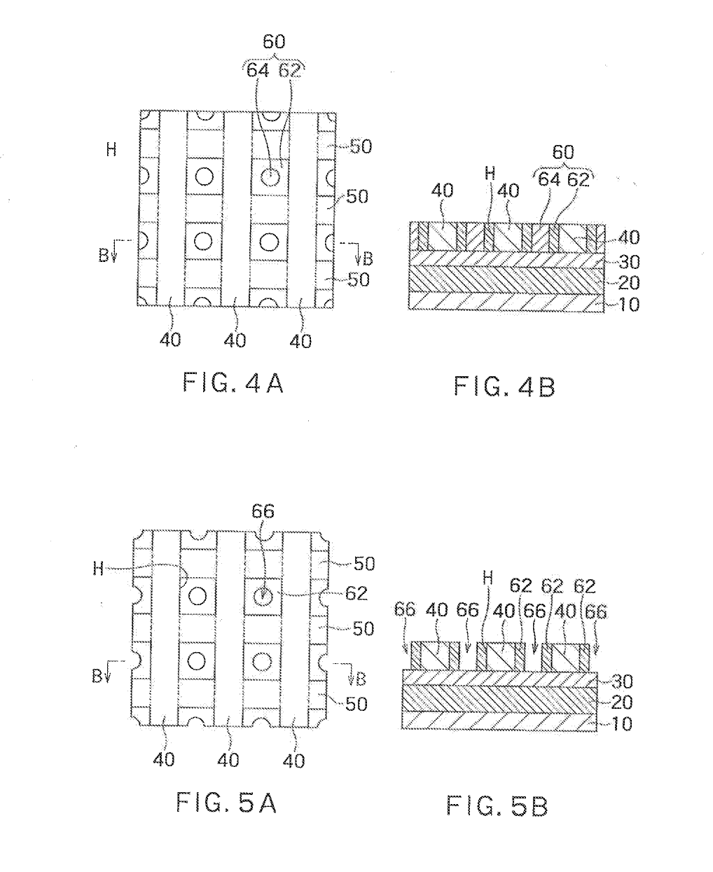

Next, the block copolymer layer 60 is phase-separated (directed self-assembled) by performing thermal processing. For example, the substrate 10 is subjected to thermal processing for 60 seconds at 240° C. using a hot plate. The resist films 40 and 50 are made of a same material, and thus the degrees of hydrophilicity on the surfaces (surface energies) of the resist films 40 and 50 are substantially the same. Accordingly, as shown in FIGS. 4A and 4B, the block copolymer layer 60 is phase-separated into a phase of a vertical cylindrical shape and a phase of a shape that surrounds the phase of a vertical cylindrical shape. For example, when PS-b-PMMA is used as the material of the block copolymer layer 60, the PS-b-PMMA is phase-separated into a PS layer (PS phase) 62 and a PMMA layer (PMMA phase) 64 in the concave portion of the hole pattern H. At this time, the PMMA layer 64 is formed in a cylindrical structure with a diameter of approximately 20 nm in a central part of the concave portion of the hole pattern H. The planar layout of the PS layer 62 and the PMMA layer 64 is formed in a substantially true circle. The PS layer 62 is formed between the PMMA layer 64 and an inner wall of the concave portion of the hole pattern H so as to surround the periphery of the PMMA layer 64. That is, the block copolymer layer 60 forms a DSA pattern of a cylindrical structure in a substantially central part of respective concave portions of the hole pattern H, with a cross-point pattern formed by the resist films 40 and 50 as a physical guide. This DSA pattern is formed one by one for the respective concave portions of the hole pattern H. As for forming such a DSA pattern, there are conditions with respect to the concave portions (physical guides) of the hole pattern H. These conditions are described later.

Next, the PMMA layer 64 is selectively etched by a CDE (Chemical Dry Etching) method or the like. With this etching process, the PMMA layer 64 in a cylindrical shape is removed while the PS layer 62 is left as it is in the concave portion of the hole pattern H. With this process, as shown in FIGS. 5A and 5B, a DSA pattern 66 of a cylindrical structure is formed in respective concave portions of the hole pattern H. As shown in FIG. 5A, the diameter of the DSA pattern 66 in a planar layout is smaller than that of the respective concave portions of the hole pattern H.

Next, by using the resist films 40 and 50 and the PS layer 62 as masks, the hard mask 30 is processed by an RIE (Reactive Ion Etching) method. That is, the DSA pattern 66 is transferred on the hard mask 30.

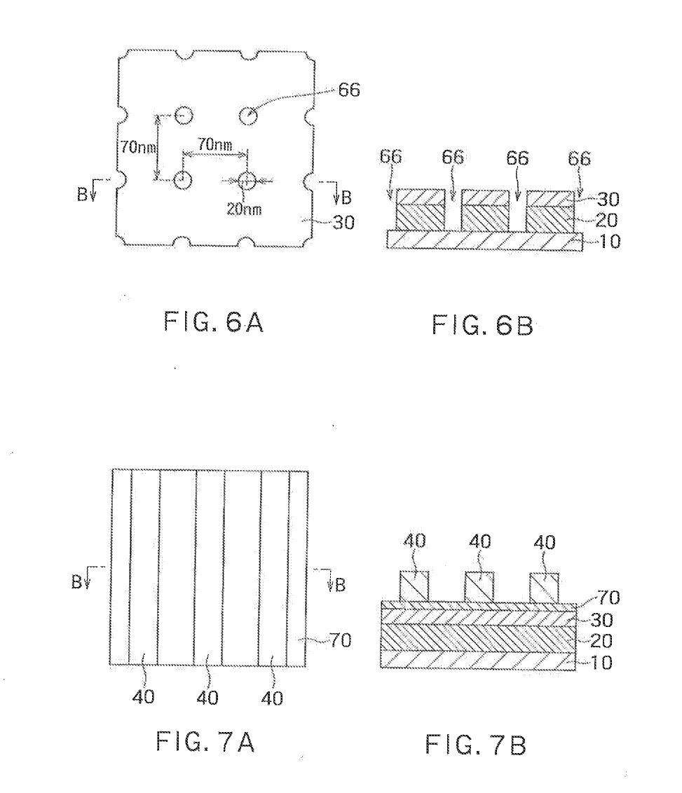

After removing the resist films 40 and 50 and the PS layer 62, the processing target film 20 is processed by the RIE method by using the hard mask 30 as a mask. With this process, as shown in FIGS. 6A and 6B, the DSA pattern 66 is transferred on the hard mask 30 and the processing target film 20. For example, when a pitch of the cross-point pattern formed by the resist films 40 and 50 is approximately 70 nm and PS-b-PMMA is used as a block copolymer, the diameter of the DSA pattern 66 in a planar layout is approximately 20 nm. Accordingly, as shown in FIG. 6A, in a planar layout, DSA patterns 66 having a diameter of approximately 20 nm are two-dimensionally arrayed in a matrix with a pitch of approximately 70 nm. The DSA patterns 66 formed on the processing target film 20 can be used for various elements such as contact holes, through silicon vias, and trench gate electrodes.

Thereafter, a semiconductor device can be formed by providing interlayer dielectric films and wires (both not shown). The first embodiment can be applied not only to semiconductor devices but also to other devices having a minute structure.

### (Conditions of Physical Guide Layer)

To phase-separate the block copolymer layer 60 in a desired pattern, predetermined conditions are required for the opening widths (W1 and W2 shown in FIG. 2A) of the hole pattern H formed by the resist films 40 and 50 as physical guide layers.

It is preferable that the opening widths W1 and W2 of a concave portion of the hole pattern H are a phase separation pitch (period) of a block copolymer, that is, substantially equal to an integral multiple of a length L of two adjacent block copolymers (micro domains) formed in the block copolymer layer 60. For example, when the length of the opening widths W1 and W2 is substantially equal to a length 2×L, the opening widths W1 and W2 correspond to one pitch of the phase separation pitch of the copolymer. Therefore, in a planar layout, in respective concave portion of the hole pattern H, one pattern (a micro phase-separated structure) can be formed. Specifically, as described above, when PS-b-PMMA is used as the block copolymer, the PMMA layer 64 having a cylindrical shape with a diameter of approximately 20 nm is formed one by one for the respective concave portions of the hole pattern H.

For example, when the opening width W1 (or W2) of the concave portion is substantially equal to a length 4×L, the opening widths W1 and W2 of the concave portion correspond to two pitches of the phase separation pitch of the copolymer. Therefore, in a planer layout, two patterns (two micro phase-separated structures) can be formed in the respective concave portions of the hole pattern H. Specifically, as described above, when PS-b-PMMA is used as the block copolymer, two PMMA layers 64 having a cylindrical shape with a diameter of approximately 20 nm are formed for the respective concave portions of the hole pattern H.

Similarly, for example, when the opening width W1 (or W2) of the concave portion is substantially equal to a length 2n×L (n is an integer equal to or larger than 3), the opening widths W1 and W2 of the concave portion correspond to n pitches of the phase separation pitch of the copolymer. Therefore, in a planer layout, n patterns (n micro phase-separated structures) can be formed in the respective concave portions of the hole pattern H. Specifically, when PS-b-PMMA is used as the block copolymer, n PMMA layers 64 having a cylindrical shape with a diameter of approximately 20 nm are formed for the respective concave portions of the hole pattern H.

As described above, it is preferable that the opening widths W1 and W2 of the concave portion are an integral multiple of a phase separation pitch of a block copolymer (the length L of two adjacent block copolymers).

As described above, according to the first embodiment, the physical guide formed by a photolithography technique has a cross-point pattern formed by a plurality of LS patterns (the resist films 40 and 50) that are substantially orthogonal to each other. The hole pattern H of the physical guide having such a cross-point pattern has an opening of a square shape (such as a quadrangle shape and a lattice shape). Furthermore, the plurality of LS patterns are made of a same material and surface energies thereof are substantially the same. When a DSA lithography technique is used in the hole pattern H, a DSA pattern of a cylindrical structure can be formed in a substantially central part of the respective concave portions of the hole pattern H. Therefore, the DSA pattern 66 can have an opening formed in a substantially true circle. In this manner, according to the first embodiment, the processing target film 20 can be processed in a round pattern of a substantially true circle while forming a physical guide layer in a lattice shape by using a plurality of LS patterns.

Generally, when a hole pattern formed by a photolithography technique as a physical guide is used, there are limitations on the gap between two adjacent holes, and it is difficult to set the gap to be smaller than a first width (for example, 80 nm). Meanwhile, the line width of the LS patterns can be set to be narrower than the first width.

Therefore, as described in the first embodiment, by forming a physical guide as a plurality of LS patterns are combined, the gap between concave portions of the hole pattern H can be made narrower than that of conventional techniques. This configuration contributes to downscaling of semiconductor devices.

Furthermore, the DSA pattern has a minuter configuration than a minimum size that can be formed by using a photolithography technique. For example, as described above, while the pitch of the LS pattern formed by the photolithography technique is approximately 70 nm, the DSA pattern becomes a cylindrical shape having a diameter of approximately 20 nm. Therefore, the DSA lithography technique can form a pattern that is smaller than the minimum size of the photolithography technique.

As described above, the pattern forming method according to the first embodiment can arrange a plurality of minute round patterns that are formed in a substantially true circle with a very narrow pitch.

Furthermore, the arrangement of round patterns formed by the processing target film 20 can be controlled by the arrangement of lattices of a physical guide layer. Therefore, the arrangement of round patterns formed on the DSA pattern 66 and the processing target film 20 can be controlled by the arrangement of LS patterns formed by the photolithography technique.

### (Modification)

In the pattern forming method according to the first embodiment, as shown in FIGS. 7A and 7B, a neutral film 70 can be formed on the hard mask 30 before forming the resist films 40 and 50. The neutral film 70 is formed by using P(S-rMMA)-OH), for example. P(S-rMMA)-OH) is a random polymer of PS and PMMA. For example, the neutral film 70 is formed by subjecting P(S-rMMA)-OH) to thermal processing for 5 minutes at 250° C. after spin coating the P(S-rMMA)-OH). Thereafter, the neutral film 70 is neutralized by rinsing the P(S-rMMA)-OH) with thinner. In this case, “neutralization” represents a characteristic between hydrophilicity and hydrophobicity. A film having affinity to a hydrophobic block (PS) or a film having affinity to a hydrophilic block (PMMA) can be used instead of the neutral film 70. In any of the cases, the block copolymer layer 60 can form a DSA pattern in the hole pattern H.

Furthermore, by performing hydrophilic treatment or hydrophobic treatment on the surface of the hard mask 30 or the resist films 40 and 50 before coating the block copolymer layer 60, a contact angle between the hard mask 30 and the resist films 40 and 50 is controlled. The surface treatment can be performed by UV irradiation, surface chemical modification, oxidation, and the like. By performing hydrophobic treatment or hydrophilic treatment on the surface of the hard mask 30 or the resist films 40 and 50, the orientation of a DSA pattern formed by the hydrophobic block (PS) or the hydrophilic block (PMMA).

In the first embodiment, a negative resist film is used as the resist films 40 and 50. The use of the negative resist film is for suppressing dissolving of the resist film 40 as the first guide layer caused by exposure when the resist film 50 as the second guide layer is formed. However, a positive resist film can be used as the resist films 40 and 50. In this case, it suffices to perform a freezing process on the resist film 40 after forming it. The freezing process can be performed by UV irradiation, surface chemical modification, thermal processing, and the like. With this process, the resist film 40 is not dissolved when the resist film 50 as the second guide layer is formed.

Further, instead of the block copolymer layer 60, it is permissible to use a blend copolymer as a material that is self-organized and phase-separated. Also, instead of the block copolymer layer 60, it is permissible to use a material in which a block copolymer is mixed with a homopolymer of one of blocks of the block copolymer, if necessary.

### Second Embodiment

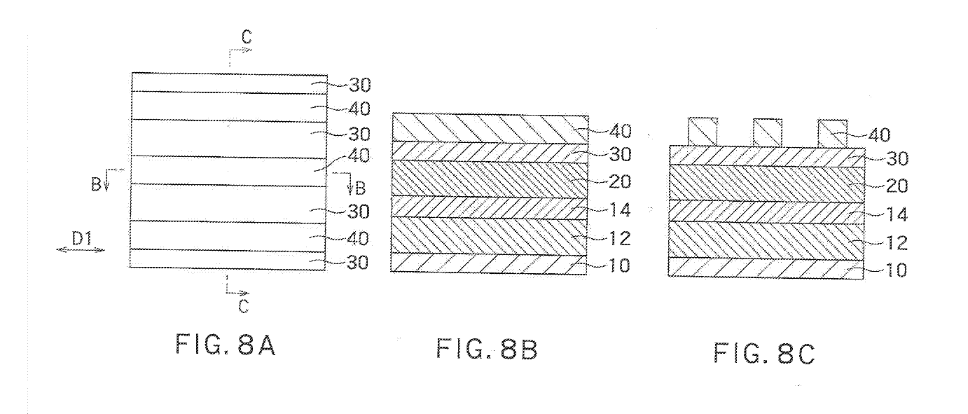

FIGS. 8A, 9A, 10A, 11A, and 12A are plan views of an example of a pattern forming method according to a second embodiment. FIGS. 8B, 9B, 10B, 11B, and 12B and FIGS. 8C, 9C, 10C, 11C, and 12C are sectional views of an example of the pattern forming method according to the second embodiment. FIGS. 8B to 12B are sectional views along with a line B-B of respectively corresponding FIGS. 8A to 12A. FIGS. 8C to 12C are sectional views along with a line C-C of respectively corresponding FIGS. 8A to 12A.

First, as shown in FIGS. 8B and 8C, materials of the processing target film 12 and of the hard mask 14 are deposited on the substrate 10. Materials of the processing target film 20 and the hard mask 30 are deposited on the hard mask 14. In the second embodiment, the processing target films 12 and 20 and the hard masks 14 and 30 are a base material. When the substrate 10 is processed, the substrate 10 can be also included in the base material. Each of the material and the film thickness of the substrate 10, the processing target film 20, and the hard mask 30 can be identical to corresponding ones described in the first embodiment.

Although the material of the processing target film 12 is not particularly limited, it can be the same as the material of the processing target film 20. For example, the processing target films 12 and 20 can be made of an APF (Advanced Patterned Film) material, for example. The thickness of the hard mask 30 is, for example, approximately 100 nm.

Although the material of the hard mask 14 is not particularly limited, it can be the same as the material of the hard mask 30. The hard masks 14 and 30 can be an antireflection dielectric film, for example. The hard mask 14 can be an insulation film such as a silicon dioxide film or a silicon nitride film. The thickness of the hard mask 14 is, for example, approximately 20 nm.

Next, the resist film 40 is coated on the hard mask 30 and the resist film 40 is exposed by ArF excimer laser. By developing the resist film 40, as shown in FIGS. 8A and 8C, a stripe-shaped LS pattern (first pattern) extending in the first direction D1 is formed. The film thickness of the resist film 40 is, for example, approximately 80 nm. The line width and the space width of the LS pattern of the resist film 40 are respectively, for example, approximately 45 nm and 90 nm. That is, the line width and the space width of the resist film 40 are formed with respect to each other with a ratio of 1:2.

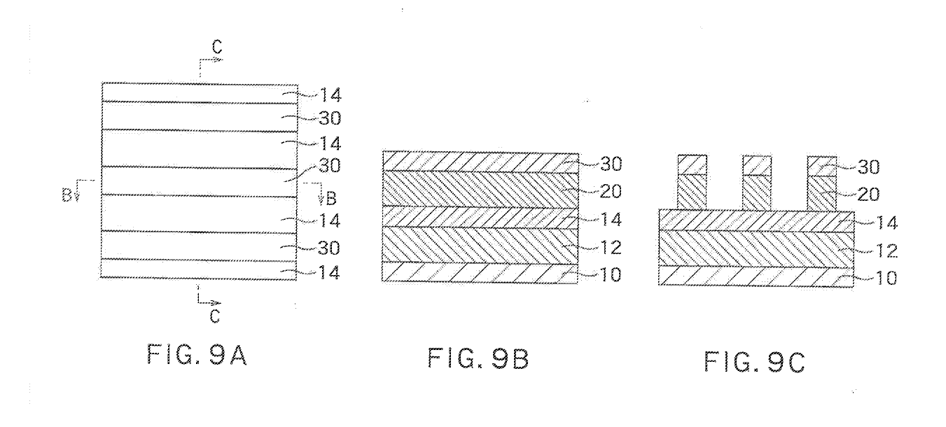

Subsequently, the hard mask 30 is processed by the RIE method by using the resist film 40 as a mask. The processing target film 20 is then processed by the RIE method by using the hard mask 30 as a mask. With this process, as shown in FIGS. 9A and 9C, the LS pattern of the resist film 40 is transferred on the processing target film 20. As shown in FIG. 9A, the hard mask 14 is exposed in a space pattern region. The processing target film 20 is present below the hard mask 30 in a line pattern region. In addition, as shown in FIG. 9B, the resist film 40 is removed at the time of processing the processing target film 20.

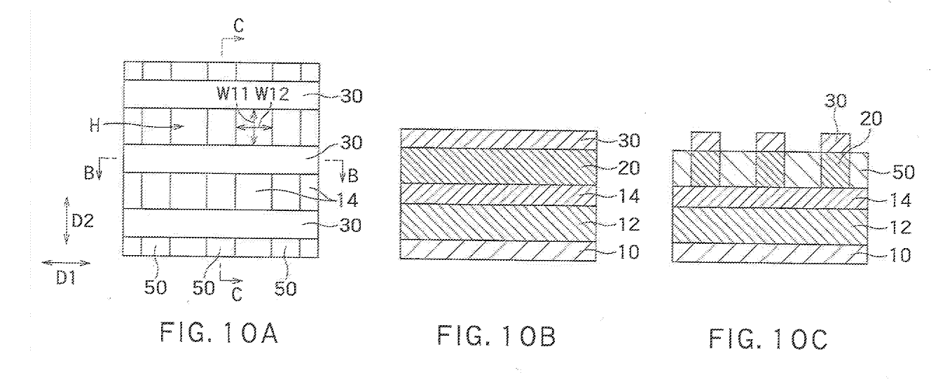

Next, as shown in FIGS. 10A to 10C, the resist film 50 is coated on the hard mask 14 and the resist film 50 is exposed by ArF excimer laser. By developing the resist film 50, as shown in FIG. 10A, a stripe-shaped LS pattern (second pattern) extending in the second direction D2 is formed such that the LS pattern intersects with the patterns of the hard mask 30 and the processing target film 20. The second direction D2 is a direction that is substantially orthogonal to the first direction D1. Therefore, in the second embodiment, the pattern of the resist film 50 intersects with the patterns of the hard mask 30 and the processing target film 20 substantially orthogonally. The film thickness of the resist film 50 is, for example, approximately 100 nm. The line width and the space width of the LS pattern of the resist film 50 are respectively, for example, approximately 45 nm and 90 nm. That is, the line width and the space width of the resist film 50 are formed with respect to each other with a ratio of 1:2.

The resist film 50 is formed on the hard mask 14 in the space pattern region. The resist film 50 faces side surfaces of the hard mask 30 and the processing target film 20. The resist film 50 is positioned lower than the hard mask 30 and is separated by the hard mask 30 in the line pattern region.

As described above, the processing target film 20 and the resist film 50 as first and second guide layers intersect with each other and form a cross-point pattern. A part surrounded by the processing target film 20 and the resist film 50 becomes a concave portion (a hole portion) having the hard mask 30 as a bottom surface. That is, it can be rephrased that the processing target film 20 and the resist film 50 form the hole pattern H. In this case, opening widths W11 and W12 of the hole pattern H are, for example, approximately 90 nm. As described later, the resist films 40 and 50 function as a physical guide in DSA lithography processing. The processing target film 20 functions as the first guide layer and the resist film 50 functions as the second guide layer.

The processing target film 20 and the resist film 50 are made of a mutually different material, and thus these films are different in their affinity (surface energy) with respect to pure water. For example, the processing target film 20 has a contact angle of approximately 53 degrees and has higher affinity with respect to a hydrophilic block (PMMA) as compared to that with respect to a hydrophobic block (PS). For example, the resist film 50 has a contact angle of approximately 72 degrees and its affinity with respect to a hydrophobic block (PS) and that with respect to a hydrophilic block (PMMA) are at the same level.

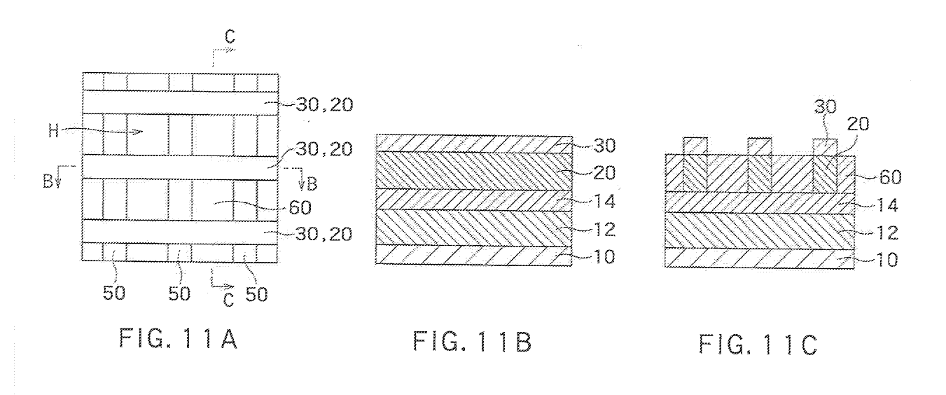

Next, as shown in FIGS. 11A to 11C, the block copolymer layer 60 is introduced into the concave portion of the hole pattern H. The material of the block copolymer layer 60 can be identical to that of the first embodiment.

Because surface energies of the processing target film 20 and the resist film 50 are mutually different from each other, for example, when PS-b-PMMA is used as the material of the block copolymer layer 60, the PS layer 62 and the PMMA layer 64 of the block copolymer layer 60 are phase-separated into a lamella structure having a half pitch of approximately 15 nm. In this case, a PS-b-PMMA solution with a concentration of approximately 2.0 Wt % is made by using PGMEA as a solvent. This PS-b-PMMA solution is coated on the resist film 50 and the hard mask 14. With this process, as shown in FIGS. 11A and 11C, the PS-b-PMMA solution is introduced in the concave portion of the hole pattern H.

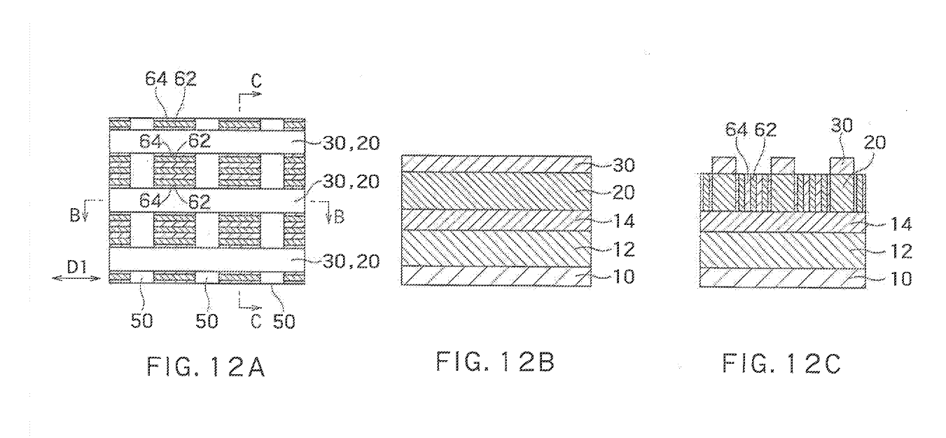

Next, the block copolymer layer 60 is phase-separated (directed self-assembled) by performing thermal processing thereon. For example, the substrate 10 is subjected to thermal processing for 60 seconds at 240° C. using a hot plate. As described above, the processing target film 20 has higher affinity with respect to a hydrophilic block (PMMA) as compared to that with respect to a hydrophobic block (PS) and, as for the resist film 50, its affinity with respect to a hydrophobic block (PS) and that with respect to a hydrophilic block (PMMA) are at the same level. Therefore, the hydrophilic PMMA layer 64 is phase-separated along with the processing target film 20 (the first guide layer) and the PS layer 62 is phase-separated as being accompanied by (as being pulled by) the PMMA layer 64. Meanwhile, the resist film 50 (the second guide layer) has the same level of (neutral) affinity with respect to both the PS layer 62 and the PMMA layer 64. Therefore, both the PS layer 62 and the PMMA layer 64 are phase-separated as each of the layers is in contact with the processing target film 20. With this characteristic, as shown in FIGS. 12A to 12C, the block copolymer layer 60 is regularly phase-separated into LS patterns along with the pattern of the processing target film 20. The half pitch of the LS patterns of the PS layer 62 and the PMMA layer 64 becomes a length L (for example, approximately 15 nm) of a block copolymer (a micro domain). Furthermore, the width of the PMMA layer 64 adjacent to the processing target film 20 becomes a half of the length L (for example, approximately 7.5 nm).

Subsequently, by selectively removing the PMMA layer 64, a minute LS pattern formed of the PS layer 62 is obtained. That is, the DSA lithography technique according to the second embodiment can form an LS pattern that is smaller than the minimum size of the photolithography technique.

In the second embodiment, a plurality of LS patterns (the processing target film 20 and the resist film 50) of a physical guide are made of a mutually different material. Accordingly, contact angles (or surface tensions) of a sidewall of the hole pattern H along with the first direction D1 and of a sidewall of the hole pattern H along with the second direction D2 are mutually different from each other. With this configuration, the PS layer 62 and the PMMA layer 64 can be oriented to the same direction. For example, the sidewall of the resist film 50 is made to be neutral and the sidewall of the processing target film 20 is made to have higher hydrophilicity than that of the sidewall of the resist film 50. With this arrangement, the PS layer 62 and the PMMA layer 64 can be oriented to an LS pattern along with an extending direction (D1) of the processing target film 20. In this manner, the second embodiment can control the orientation of a phase-separated block copolymer with combining a physical guide and a chemical guide. The space width of the pattern of the processing target film 20 (the first guide layer) needs to be controlled as the space width is matched with the length of the corresponding polymer. However, the space width of the pattern of the resist film 50 (the second guide layer) does not need to be matched with the length of the corresponding polymer, and the pattern can be formed as its space width being matched with that of a desired device pattern.

### (Modification)

In the second embodiment, a physical guide is constituted by the processing target film 20 and the resist film 50, which are made of a mutually different material. However, in the respective concave portions of the hole pattern H, surface conditions (hydrophilic or hydrophobic) of two pairs of inner surfaces can be intentionally made different from each other according to the type of surface processing. For example, any one or both of the first guide layer and the second guide layer are subjected to surface processing. With this processing, contact angles of the first guide layer and the second guide layer are made different from each other. That is, one of the first guide layer and the second guide layer has affinity with respect to one of the PS layer 62 and the PMMA layer 64, and the other one of the first and second layers have affinity at the same level with respect to both the PS layer 62 and the PMMA layer 64. In this manner, in this modification, the orientation of a DSA pattern can be controlled similarly to the second embodiment.

Furthermore, the first guide layer (the processing target film 20) and the second guide layer (the resist film 50) can have a mutually different height. With this configuration, the surface of the block copolymer layer 60 can have a meniscus shape. The height of such a block copolymer layer 60 changes between two adjacent resist films 50. That is, the height from the surface of the hard mask 14 to the surface of the block copolymer layer 60 changes between two adjacent first guide layer (or two second guide layer). The orientation and position of the phase-separation pattern of the PS layer 62 and the PMMA layer 64 can be controlled by using the change of the height of such a block copolymer layer 60.

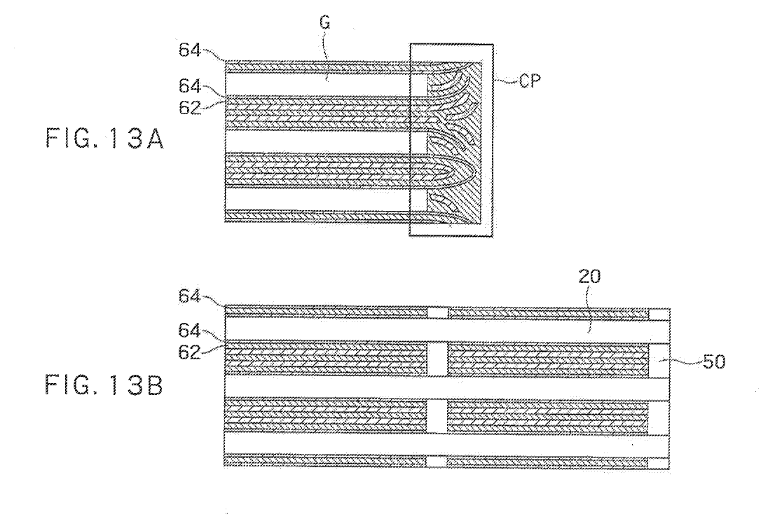

In the second embodiment, instead of using a simple LS pattern, a cross-point pattern is used as a physical guide. When a simple LS pattern is used as a physical guide as shown in FIG. 13A, because the distal end of a physical guide G is not closed, the PS layer 62 and the PMMA layer 64 are formed in a disorganized pattern. In this case, a cutting pattern CP needs to be formed between two adjacent chips to eliminate the disorganized pattern. FIG. 13A is a plan view showing phase-separation of a copolymer using an LS pattern and FIG. 13B is a plan view showing phase-separation of a copolymer using a cross-point pattern.

Meanwhile, as shown in FIG. 13B, the cross-point pattern also has another pattern (such as the resist film 50) in a direction substantially orthogonal to an LS pattern (such as the processing target film 20). Accordingly, because the distal end of the LS pattern is not open, the PS layer 62 and the PMMA layer 64 do not form any disorganized pattern at the distal end of the physical guide (the processing target film 20). Therefore, it is not necessary to form a cutting pattern between two adjacent chips. As a result, the distance between chips can be significantly reduced.

### Third Embodiment

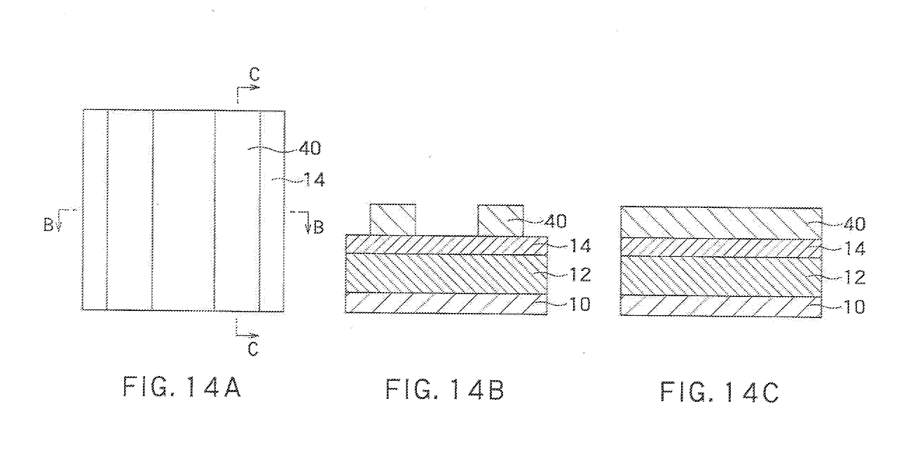

FIGS. 14A, 15A, 16A, 17A, 18A, 19A, 20A, 21A, and 22A are plan views of an example of a pattern forming method according to a third embodiment. FIGS. 14B, 15B, 16B, 17B, 18B, 19B, 20B, 21B, and 22B and FIGS. 14C, 15C, 16C, 17C, 18C, 19C, 20C, 21C, and 22C are sectional views of an example of the pattern forming method according to the third embodiment. FIGS. 14B to 12B are sectional views along with a line B-B of respectively corresponding FIGS. 8A to 12A As for FIGS. 14 to 22, the drawings denoted as “B” are sectional views along with a line B-B of respectively corresponding drawings denoted as “A”, and the drawings denoted as “C” are sectional views along with a line C-C of respectively corresponding drawings denoted as “A”.

First, as shown in FIGS. 14B and 14C, materials of the processing target film 12 and of the hard mask 14 are deposited on the substrate 10. In the third embodiment, the processing target film 12 and the hard mask 14 are a base material. When the substrate 10 is processed, the substrate 10 can be also included in the base material. Each of the material and the film thickness of the substrate 10, the processing target 12, and the hard mask 14 can be identical to corresponding ones described in the second embodiment.

Next, the resist film 40 is coated on the hard mask 14 and the resist film 40 is exposed by ArF excimer laser. The film thickness of the resist film 40 is, for example, 100 nm. By developing the resist film 40, as shown in FIG. 14A, a stripe-shaped LS pattern is formed. The line width and the space width of the LS pattern of the resist film 40 are respectively, for example, approximately 90 nm and 130 nm.

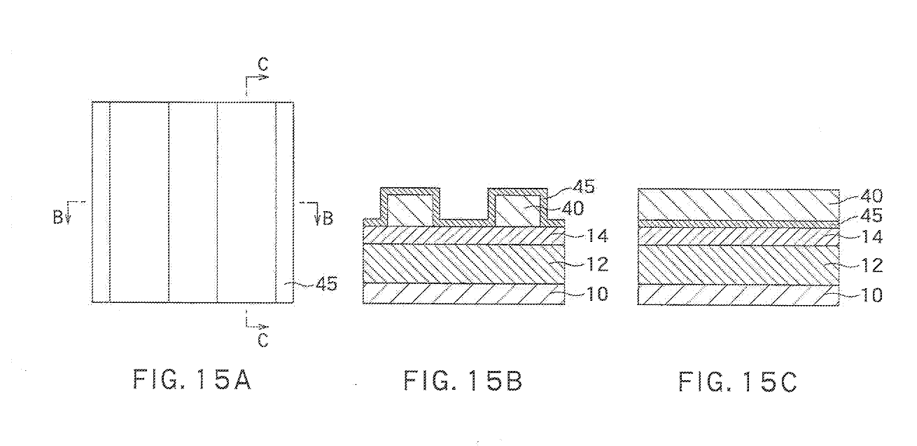

Subsequently, as shown in FIGS. 15A to 15C, the material of a sidewall film 45 is deposited on a top surface and a side surface of the resist film 40. The material of the sidewall film 45 is, for example, a silicon dioxide film. For example, the film thickness of the sidewall film 45 is approximately 20 nm.

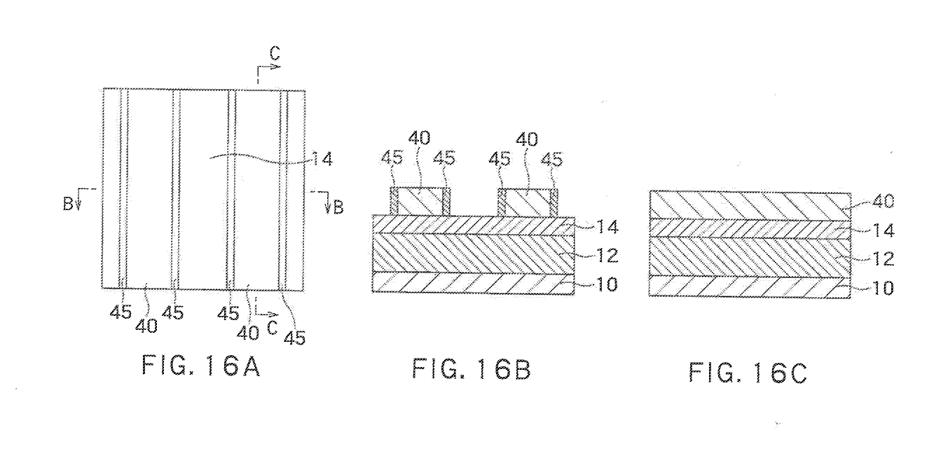

Next, as shown in FIGS. 16A to 16C, by etching back the material of the sidewall film 45, the sidewall film 45 is left on a side surface of the resist film 40.

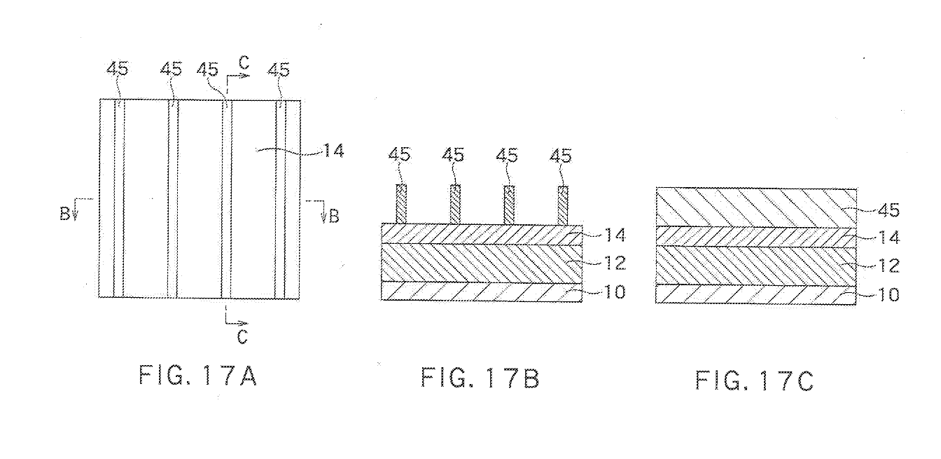

Subsequently, by removing the resist film 40, the configuration shown in FIGS. 17A to 17C can be obtained. The line width and the space width of the LS pattern of the sidewall film 45 are respectively, for example, approximately 20 nm and 110 nm.

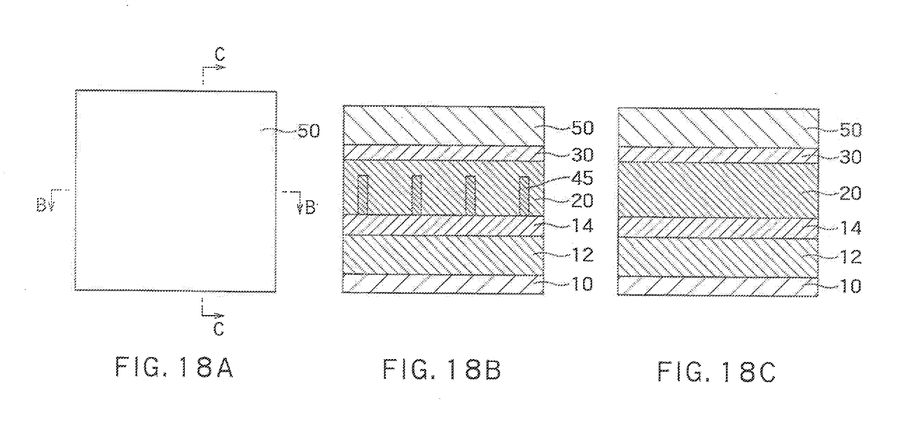

Next, as shown in FIGS. 18A to 18C, materials of the processing target film 20 and the hard mask 30 are deposited on the hard mask 14 and the sidewall film 45. Respective materials of the processing target film 20 and the hard mask 30 can be identical to those of the first embodiment. The film thickness of the processing target material is, for example, approximately 120 nm. The film thickness of the hard mask 30 is, for example, approximately 20 nm.

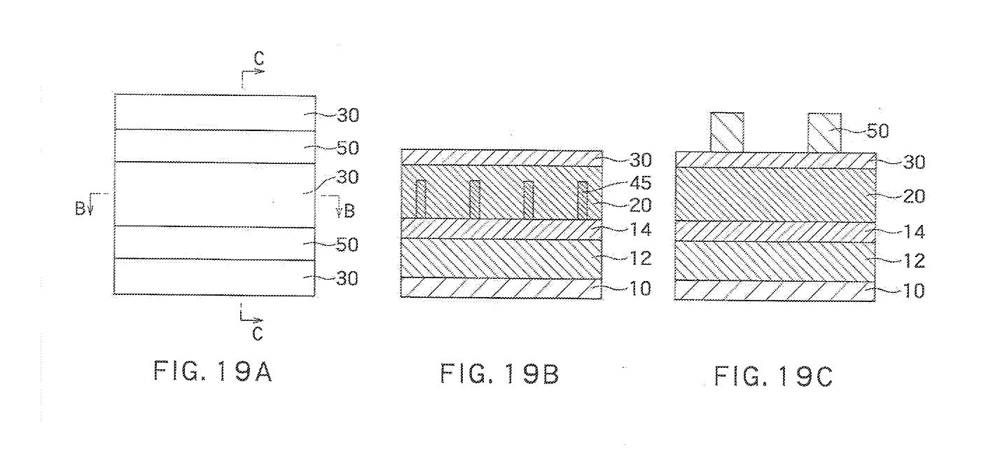

Next, the resist film 50 is coated on the hard mask 30 and the resist film 50 is exposed by ArF excimer laser. By developing the resist film 50, as shown in FIGS. 19A to 19C, a stripe-shaped LS pattern (second pattern) is formed such that the LS pattern intersects with the pattern of the sidewall film 45. That is, in the third embodiment, the pattern of the resist film 50 intersects with the pattern of the sidewall film 45 substantially orthogonally. The film thickness of the resist film 50 is, for example, approximately 80 nm. The line width and the space width of the LS pattern of the resist film 50 are respectively, for example, approximately 45 nm and 90 nm. That is, the line width and the space width of the resist film 50 are formed with respect to each other with a ratio of 1:2.

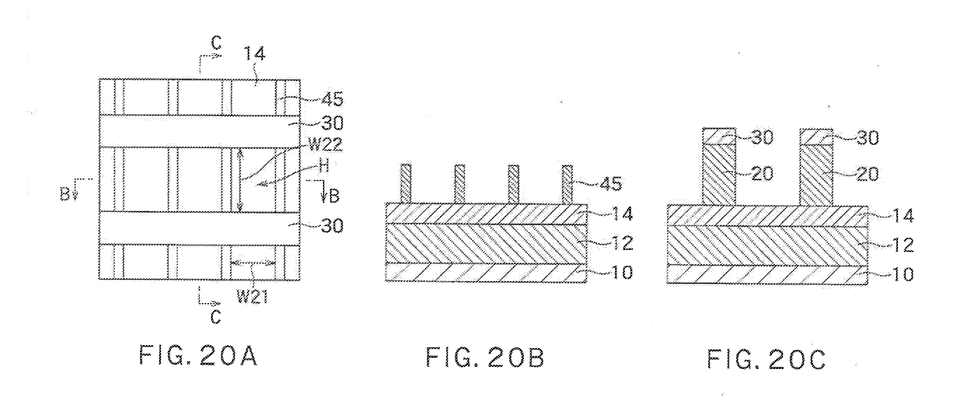

Next, the hard mask 30 is processed by the RIE method by using the resist film 50 as a mask. The processing target film 20 is then processed by using the hard mask 30 as a mask. With this process, as shown in FIGS. 20A to 20C, the LS pattern of the resist film 50 is transferred on the processing target film 20. At this time, the sidewall film 45 is left as it is.

As described above, the processing target film 20 and the sidewall film 45 intersect with each other to form a cross-point pattern. A part surrounded by the processing target film 20 and the sidewall film 45 becomes a concave portion (a rectangle hole portion) having the hard mask 14 as a bottom surface. That is, it can be rephrased that the processing target film 20 and the sidewall film 45 form the hole pattern H. In this case, opening widths W21 and W22 of the hole pattern H are respectively, for example, approximately 110 nm and 90 nm. As described later, the processing target film 20 and the sidewall film 45 function as a physical guide in DSA lithography processing. The processing target film 20 functions as the first guide layer and the sidewall film 45 functions as the second guide layer.

Next, surface treatment of the sidewall film 45 is performed. The surface treatment is a process such as subjecting P(S-rMMA) to thermal processing for 5 minutes at 250° C. after spin coating the P(S-rMMA). Thereafter, the sidewall film 45 is selectively neutralized by rinsing P(S-rMMA)-OH) with thinner. The P(S-rMMA)-OH) has reactivity to the sidewall film 45 and is formed on the surface of the sidewall film 45. However, the P(S-rMMA)-OH) does not react to the processing target film 20. That is, by this surface treatment, the sidewall film 45 (such as a silicon dioxide film) can be selectively neutralized without neutralizing the processing target film 20 (such as SOC).

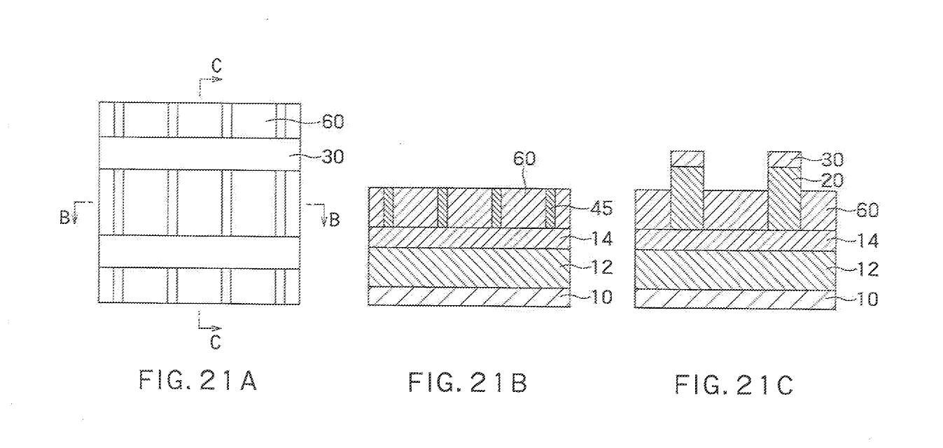

Subsequently, as shown in FIGS. 21A to 21C, the block copolymer layer 60 introduced into the concave portion of the hole pattern H. The material of the block copolymer layer 60 can be identical to that of the first embodiment.

Because surface energies of the processing target film 20 and the sidewall film 45 are mutually different from each other, for example, when PS-b-PMMA is used as the material of the block copolymer layer 60, the PS layer 62 and the PMMA layer 64 are phase-separated into a lamella structure having a half pitch of approximately 15 nm. In this case, a PS-b-PMMA solution with a concentration of approximately 2.0 Wt % is made by using PGMEA as a solvent. This PS-b-PMMA solution is coated on the hard masks 14 and 30. With this process, as shown in FIGS. 21A to 21C, the PS-b-PMMA solution is introduced in the concave portion of the hole pattern H.

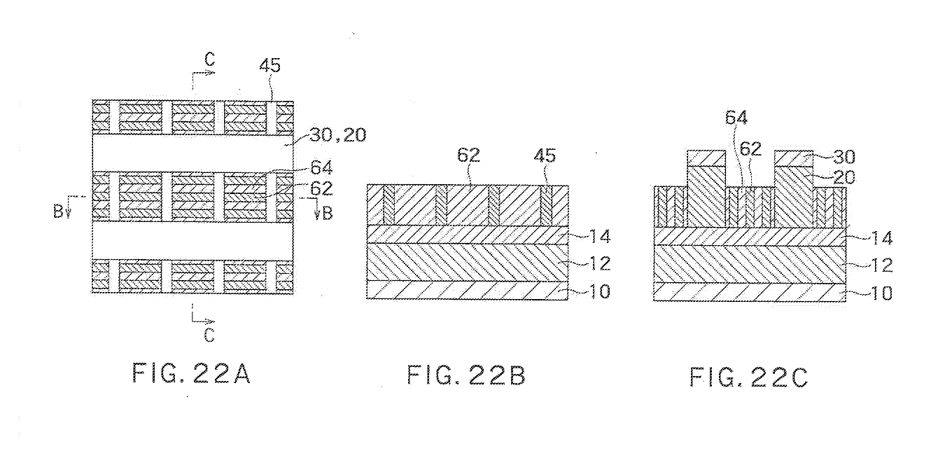

Next, the block copolymer layer 60 is phase-separated (directed self-assembled) by performing thermal processing. For example, the substrate 10 is subjected to thermal processing for 60 seconds at 240° C. using a hot plate. With this process, the hydrophilic PMMA layer 64 is phase-separated along with the processing target film 20 (the second guide layer) and the PS layer 62 is phase-separated as being accompanied by (as being pulled by) the PMMA layer 64. Meanwhile, the sidewall film 45 (the first guide layer) has the same level of (neutral) affinity with respect to both the PS layer 62 and the PMMA layer 64. Therefore, both the PS layer 62 and the PMMA layer 64 are phase-separated as each of the layers is in contact with the sidewall film 45. With this characteristic, as shown in FIGS. 22A to 22C, the block copolymer layer 60 is regularly phase-separated into LS patterns along with the pattern of the processing target film 20. The half pitch of the LS patterns of the PS layer 62 and the PMMA layer 64 becomes a length L (for example, approximately 15 nm). Furthermore, the width of the PMMA layer 64 adjacent to the processing target film 20 becomes a half of the length L (for example, approximately 7.5 nm).

Next, by selectively removing the PMMA layer 64, a minute LS pattern formed of the PS layer 62 is obtained. That is, the DSA lithography technique according to the third embodiment can also achieve effects identical to those of the second embodiment. Furthermore, this modification of the second embodiment can be also applied to the third embodiment.

### Fourth Embodiment

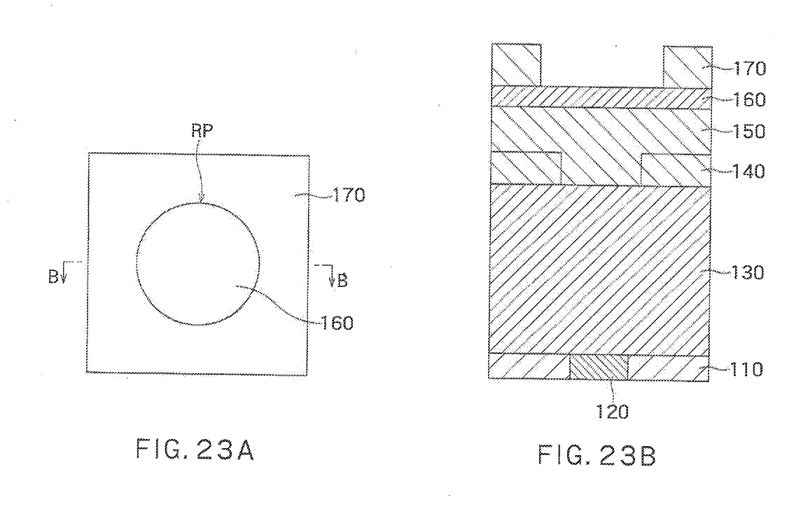

FIGS. 23A, 24A, 25A, 26A, and 27A are plan views of an example of a pattern forming method according to a fourth embodiment. FIGS. 23B, 24B, 25B, 26B, and 27B are sectional views of an example of the pattern forming method according to the fourth embodiment. FIGS. 23B to 27B are sectional views along with a line B-B of respectively corresponding FIGS. 23A to 27A. In the fourth embodiment, a contact hole is formed by phase-separation of a block copolymer.

As shown in FIG. 23B, a lower layer wire 120 is formed in an interlayer dielectric film 110. The surface of the lower layer wire 120 is exposed from the interlayer dielectric film 110. For example, the lower layer wire 120 is formed in a line pattern of approximately 20 nm.

An interlayer dielectric film 130 is deposited on the interlayer dielectric film 110 and the lower layer wire 120. The film thickness of the interlayer dielectric film 130 is, for example, 100 nm.

Next, a hard mask 140 is formed on the interlayer dielectric film 130. The hard mask 140 is formed with a layout pattern (an LS pattern) that is substantially the same as that of the lower layer wire 120. However, the space width of the hard mask 140 is approximately 30 nm, for example. The hard mask 140 is made of TIN, for example.

Subsequently, a processing target film 150 is deposited on the hard mask 140 and the interlayer dielectric film 130. The material of the processing target film 150 can be the same as that of the processing target film 20 according to the first embodiment. The film thickness of the processing target film 150 is, for example, approximately 100 nm. Furthermore, a hard mask 160 is deposited on the processing target film 150. For example, the hard mask 160 is a silicon dioxide film formed of SOG. For example, the film thickness of the hard mask 160 is approximately 30 nm.

Next, a negative resist film 170 (hereinafter, “resist film 170”) is coated on the hard mask 160 and the resist film 170 is exposed by ArF excimer laser. The film thickness of the resist film 170 is, for example, approximately 100 nm. By developing the resist film 170, as shown in FIG. 23A, a round pattern RP is formed. The diameter of the round pattern RP of the resist film 170 is, for example, approximately 50 nm. That is, the diameter of the round pattern RP of the resist film 170 is larger than the space width of the hard mask 140.

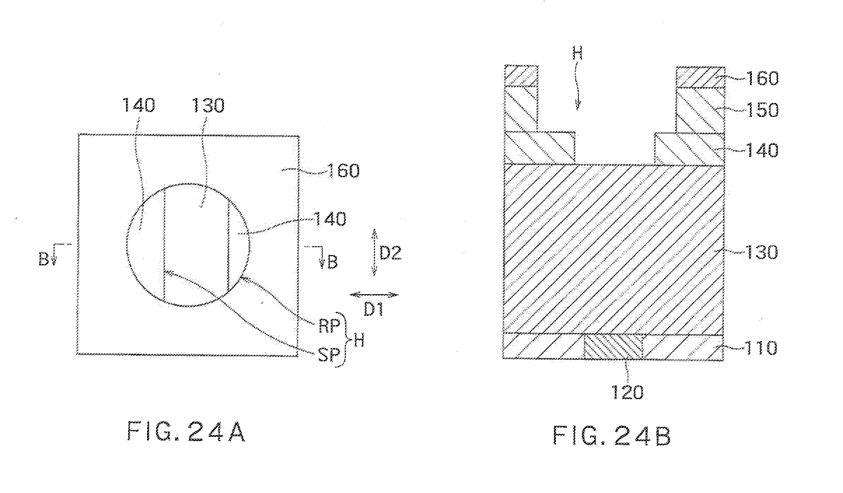

Next, the hard mask 160 is processed by the RIE method by using the resist film 170 as a mask. Subsequently, the processing target film 150 is processed by the RIE method by using the hard mask 160 as a mask. With this process, as shown in FIGS. 24A and 24B, the round pattern RP of the resist film 170 is transferred on the processing target film 150. Furthermore, as shown in FIG. 24A, the round pattern RP is formed to overlap on a part of the space pattern SP of the hard mask 140. In FIG. 24A, the hard mask 140 has an LS pattern extending in the second direction D2 that is substantially orthogonal to the first direction D1. The round pattern RP has alignment deviation to a left side direction (the first direction D1) with respect to the space pattern SP of the hard mask 140.

In this case, the space pattern SP of the hard mask 140 and the round pattern RP of the processing target film 150 form a cross-point pattern. A part surrounded by the processing target pattern 150 and the hard mask 140 becomes a concave portion (a hole portion) having the interlayer dielectric film 130 as its bottom surface. That is, it can be rephrased that the processing target pattern 150 and the hard mask 140 form the hole pattern H. As described later, the processing target film 150 and the hard mask 140 function as a physical guide in DSA lithography processing. The space pattern SP of the hard mask 140 and the round pattern RP of the processing target film 150 become first and second patterns, respectively. That is, the hard mask 140 functions as a first guide layer and the processing target film 150 functions as a second guide layer.

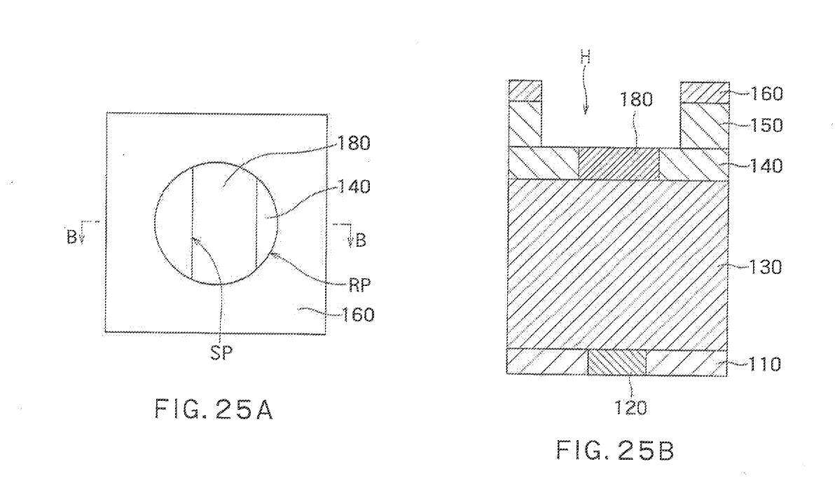

Next, as shown in FIGS. 25A and 25B, a block copolymer layer 180 is introduced into the concave portion of the hole pattern H. The material of the block copolymer layer 180 can be identical to that of the first embodiment.

For example, when PS-b-PMMA is used as the material of the block copolymer layer 180, if the PS-b-PMMA is phase-separated into PS and PMMA under conditions of the physical guide layer mentioned above, the PMMA has a cylindrical structure with a diameter of approximately 20 nm. In this case, a PS-b-PMMA solution with a concentration of approximately 2.0 Wt % is made by using PGMEA as a solvent. This PS-b-PMMA solution is coated on the hard masks 14 and 30. With this process, as shown in FIGS. 25A and 25B, the PS-b-PMMA solution is introduced in the concave portion of the hole pattern H.

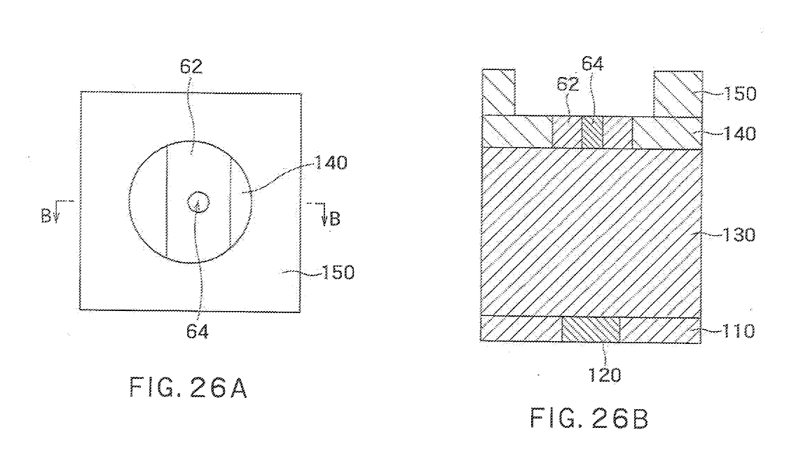

Next, the block copolymer layer 180 is phase-separated by performing thermal processing. For example, the block copolymer layer 180 is subjected to thermal processing for 60 seconds at 240° C. using a hot plate. With this process, as shown in FIGS. 26A and 26B, the block copolymer layer 180 is phase-separated in a vertical cylindrical shape. For example, PS-b-PMMA as the block copolymer layer 180 is phase-separated into the PS layer 62 and the PMMA layer 64 in the concave portion of the hole pattern H. In this case, the PMMA layer 64 is in a cylindrical shape with a diameter of approximately 20 nm in a central part of the concave portion of the hole pattern H. The planar layout of the PS layer 62 and the PMMA layer 64 is formed in a substantially true circle. The PS layer 62 is formed between the PMMA layer 64 and an inner wall of the concave portion of the hole pattern H so as to surround the periphery of the PMMA layer 64. That is, the block copolymer layer 180 forms a DSA pattern of a cylindrical structure in a substantially central part of respective concave portions of the hole pattern H, with a cross-point pattern formed by the processing target film 150 and the hard mask 140 as a physical guide. This DSA pattern is formed one by one for the respective concave portions of the hole pattern H. In order to form such a DSA pattern, the width of the concave portions of the hole pattern H (the width of the space pattern SP) needs to comply with the conditions of the physical guide layer.

Subsequently, the PMMA layer 64 is selectively etched by the CDE method or the like. With this etching process, the PMMA layer 64 in a cylindrical shape is removed while the PS layer 62 is left as it is in the concave portion of the hole pattern H.

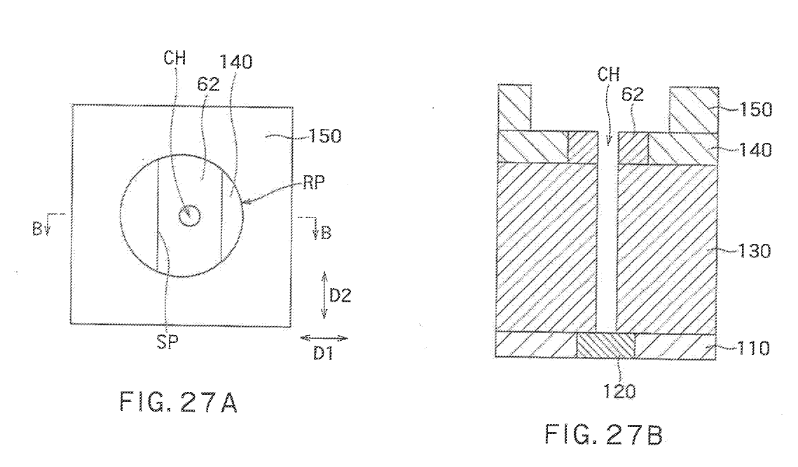

Next, the interlayer dielectric film 130 is etched by the RIE method by using the PS layer 62 as a mask. With this etching, as shown in FIGS. 27A and 27B, the DSA pattern 66 in a cylindrical shape is formed in respective concave portions of the hole pattern H. As shown in FIG. 27B, a contact hole CH that reaches the lower layer wire 120 is formed. The diameter of the contact hole CH is substantially identical to the diameter of the PMMA layer 64, and it is approximately 20 nm. As described above, the DSA lithography technique according to the fourth embodiment can form a pattern having a size that is smaller than a minimum size of the photolithography technique.

In the fourth embodiment, a cross-point pattern formed by an LS pattern (the hard mask 140) and a round pattern (the processing target film 150) is used as a physical guide of the DSA lithography technique. The hard mask 140 as the first guide layer defines the position of the contact hole in the first direction D1. The processing target film 150 as the second guide layer defines the position of the contact hole CH in the second direction D2. Therefore, the position of the contact hole CH is determined in a self-aligned manner according to the cross-point pattern formed by the hard mask 140 and the processing target film 150.

When the processing target film 150 has alignment deviation to some extent in the first direction D1, the position of the contact hole CH is not shifted. Furthermore, when the hard mask 140 has alignment deviation to some extent in the second direction D2, the position of the contact hole CH is not shifted. That is, the pattern forming method according to the fourth embodiment can form a minute contact hole CH in a self-aligned manner, and positional deviation of the contact hole CH can be suppressed to some extent. In this case, in the fourth embodiment, it is not necessary to perform taper processing that is difficult to control.

Furthermore, a contact angle between the hard mask 140 and the processing target film 150 can be controlled by subjecting the surfaces of the hard mask 140 and the processing target film 150 to surface treatment. Similarly to the modification of the first embodiment, the surface treatment of the fourth embodiment can be performed by UV irradiation, surface chemical modification, oxidation, and the like. Further, as a material to be directed self-assembled and phase-separated, a blend polymer can be used instead of the block copolymer layer 180.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A pattern forming method comprising:
forming a first guide layer having a first pattern above a base material;
forming a second guide layer having a second pattern intersecting the first pattern;
introducing a directed self-assembly material in a concave portion surrounded by the first and second guide layers; and
forming a directed self-assembly pattern having a diameter which is smaller than an opening diameter of the concave portion in the concave portion by causing the directed self-assembly material to be phase-separated.

2. The method of claim 1, further comprising processing the base material by using the directed self-assembly pattern.

3. The method of claim 1, wherein the directed self-assembly of the directed self-assembly material is performed by subjecting the base material to thermal processing.

4. The method of claim 1, wherein
the first and second patterns are stripe-shaped patterns intersecting with each other, and
the first and second guide layers form a lattice pattern with the first and second patterns.

5. The method of claim 4, wherein the directed self-assembly pattern is a cylindrical pattern formed in a concave portion of respective lattices of the lattice pattern.

6. The method of claim 4, wherein an opening width of the concave portion of the lattice pattern is substantially equal to an integral multiple of a phase separation pitch of the directed self-assembly material.

7. The method of claim 5, wherein an opening width of the concave portion of the lattice pattern is substantially equal to an integral multiple of a phase separation pitch of the directed self-assembly material.

8. The method of claim 1, wherein the directed self-assembly material includes a block copolymer (PS-b-PMMA) of polystyrene and polymethylmethacrylate.

9. The method of claim 5, wherein the directed self-assembly material includes a block copolymer (PS-b-PMMA) of polystyrene and polymethylmethacrylate.

10. The method of claim 4, wherein
the first guide layer and the second guide layer are different from each other in affinity with respect to pure water, and
the directed self-assembly pattern is a line and space pattern formed in a concave portion of respective lattices of the lattice pattern.

11. The method of claim 1, wherein the first pattern and the second pattern are made of a mutually different material.

12. The method of claim 1, wherein
one of the first pattern and the second pattern has equal affinity with respect to both phases formed by phase-separating the directed self-assembly material, and
the other one of the first pattern and the second pattern has higher affinity to one of phases formed by phase-separation as compared to that of the other one of the phases.

13. The method of claim 1, wherein
at least one of the first pattern and the second pattern is subjected to surface treatment before introducing the directed self-assembly material, and
one of the first pattern and the second pattern has equal affinity with respect to both phases formed by phase-separating the directed self-assembly material, and the other one of the first pattern and the second pattern has higher affinity to one of phases formed by phase-separation as compared to that of the other one of the phases.

14. The method of claim 13, wherein the surface treatment is performed by UV irradiation, surface chemical modification, or oxidation.

15. The method of claim 1, wherein
the first guide layer and the second guide layer have a mutually different height, and
when the directed self-assembly material is introduced in the first and second guide layers, the directed self-assembly material has a meniscus shape.

16. The method of claim 10, wherein
the first guide layer and the second guide layer have a mutually different height, and
when the directed self-assembly material is introduced in the first and second guide layers, the directed self-assembly material has a meniscus shape.
